(19) United States
(12) Patent Application Publication
(10) Pub. No.: US 2014/0058902 A1
(43) Pub. Date: Feb. 27, 2014

(54) DISTRIBUTED SYSTEM FOR REMOTE ORDERING

(71) Applicant: Ovni, Inc., San Francisco, CA (US)

(72) Inventors: Amit Moses TAYLOR, San Francisco, CA (US); Eric Michael HALL, Mountain View, CA (US)

(21) Appl. No.: 13/972,625

(22) Filed: Aug. 21, 2013

Related U.S. Application Data
(60) Provisional application No. 61/691,523, filed on Aug. 21, 2012.

(51) Int. Cl. G06Q 30/06

(52) U.S. Cl. CPC G06Q 30/0635
USPC 705/26.81

(57) ABSTRACT

Methods and systems for remote ordering. The methods and systems may include receiving vendor information associated with a plurality of vendors and transmitting the vendor information for presentation on a wireless device. In addition, the methods and systems may include receiving an order from the wireless device, wherein the order includes a selection of at least one item from the vendor information associated with a vendor and transmitting the order to the vendor for processing. The methods and systems may also include receiving a notification in real time or near real time with an order status from the vendor and transmitting the notification to the wireless device.

### RELATED APPLICATIONS

This application claims the benefit of priority to U.S. Provisional Application No. 61/691,523 entitled “Methods and Systems for Remote Ordering,” filed Aug. 21, 2012. The preceding application is incorporated by reference in its entirety herein.

### BACKGROUND

Currently, about 95% of independent restaurants do not have wireless device applications, and only about 40% have online menus. Accordingly, it is difficult for customers to place orders in restaurants that do not have mobile sites or wireless device applications, unless they are physically present at the restaurant or are willing to deal with the inconveniences of coordinating an order through a telephone call. In addition, even if a number of restaurants have online menus, it is often difficult for a user to access all the menus via a wireless device, such as a smart phone or a smart tablet, because the menus are likely to be located in different places online. A similar problem exists for other types of vendors, such as grocery stores, vendors, retailers, service providers, and the like. Furthermore, even if a number of restaurants may have their own wireless device applications that can be downloaded to, for example, a smart phone or a smart tablet, the wireless device owner may not want to have a large number of applications, one for each restaurant, retailer, grocery store, or the like, displayed on the relatively small screen of the wireless device.

Accordingly, there is a need in the art to provide a wireless device owner or user with a single platform from which the wireless device owner or user may be able to access a variety of services, such as ordering food, making a doctor's appointment, ordering groceries, and the like.

### SUMMARY

Aspects of the present invention relate to methods and systems for remote access to vendors by customers. More particularly, aspects of the present invention provide systems and methods for providing a wireless device user with the ability to order one or more goods or services from a plurality of vendors, retailers, and the like, via a single wireless device.

According to various aspects, the method may include viewing vendor information on a screen of the wireless device, selecting a vendor based on the vendor information, selecting at least one item from the selected vendor, selecting one or more sub-items corresponding to the selected item, and/or placing an order for the selected item.

Additional advantages and novel features relating to aspects of the present invention will be set forth in part in the description that follows, and in part will become more apparent to those skilled in the art upon examination of the following or upon learning by practice thereof.

### DESCRIPTION OF THE FIGURES

In the drawings:

FIG. 1 illustrates a system for remote ordering of goods and/or services according to various aspects of the current invention;

FIG. 2 illustrates an example connectivity system in accordance with an aspect of the present invention;

FIG. 3 is a flowchart illustrating a method for remote ordering of goods and/or services according to various aspects of the current invention;

FIG. 4 illustrates a method flow for managing orders of items in accordance with an aspect of the present invention;

FIG. 5 illustrates a method flow for processing an order in accordance with an aspect of the present invention;

FIGS. 6A-6O are diagrams illustrating example screen shots according to various aspects of the current invention;

FIG. 7 presents an example system diagram of various hardware components and other features, for use in accordance with an aspect of the present invention; and

FIG. 8 is a block diagram of various example system components, in accordance with an aspect of the present invention.

### DETAILED DESCRIPTION

These and other features and advantages in accordance with aspects of this invention are described in, or are apparent from, the following detailed description of various example features and implementations thereof.

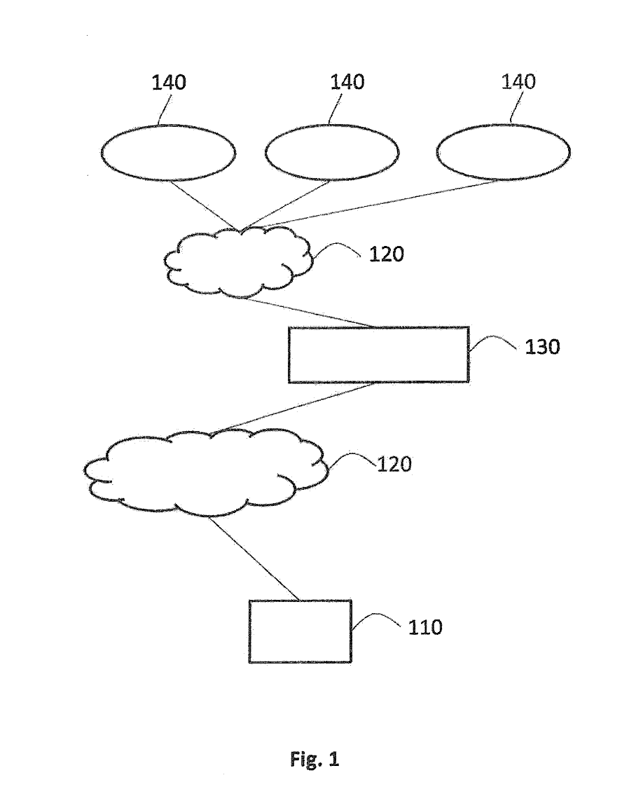

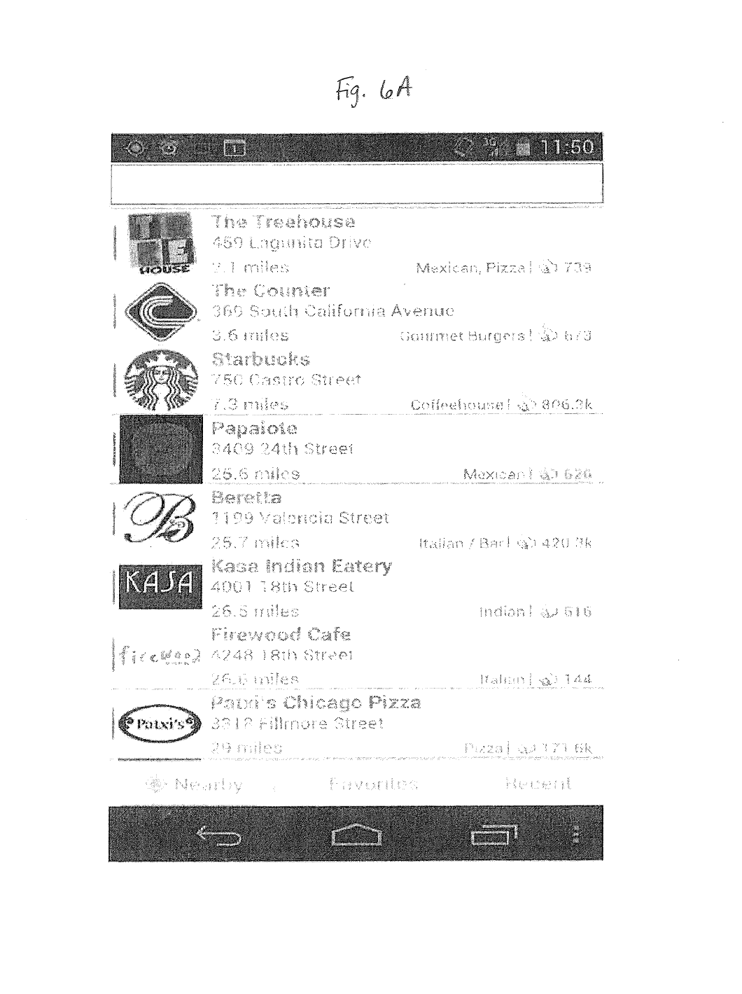

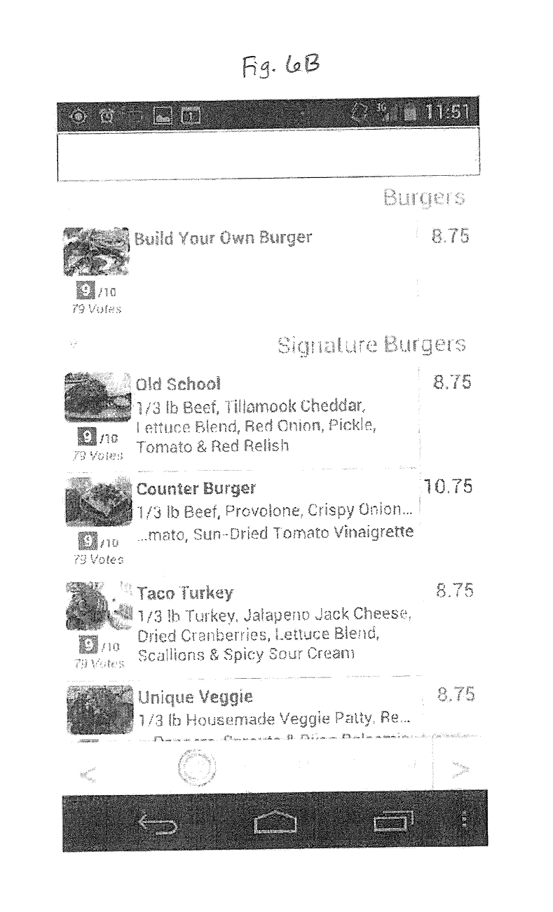

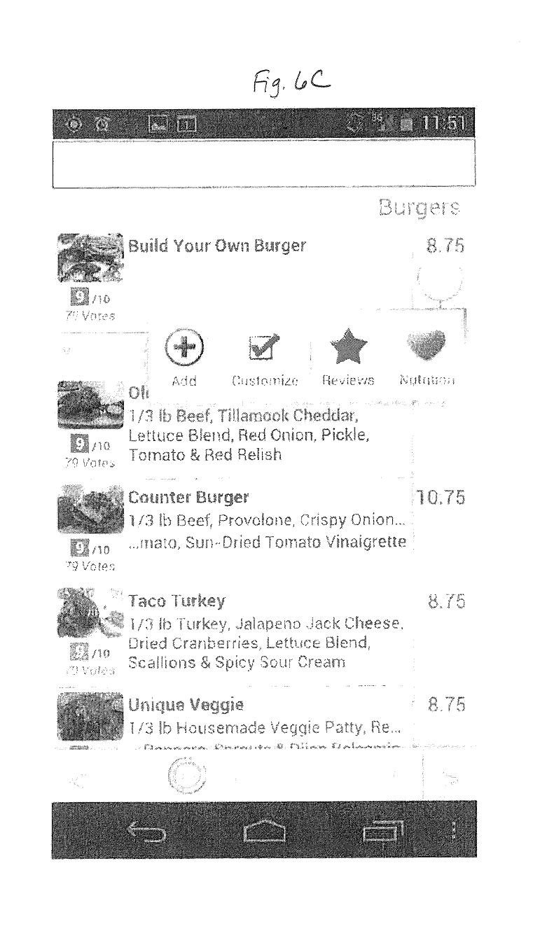

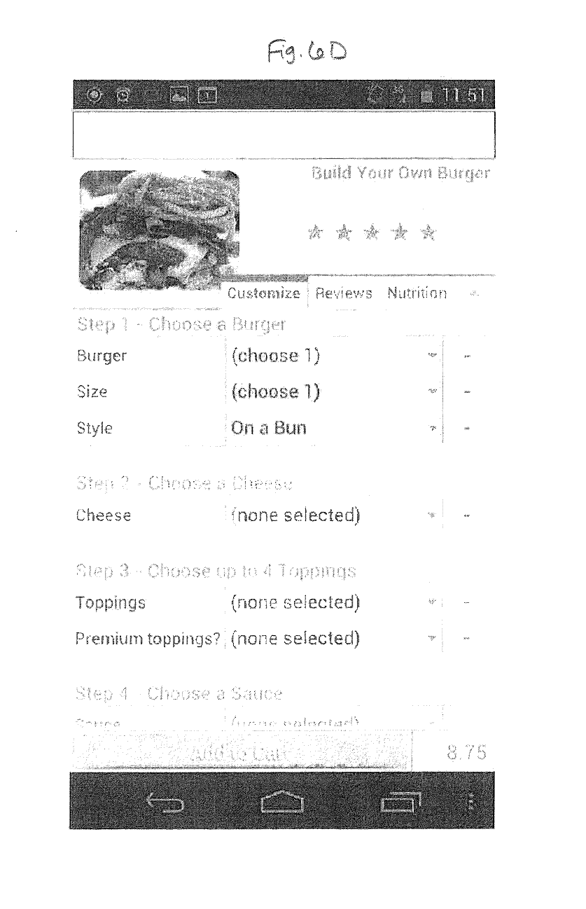

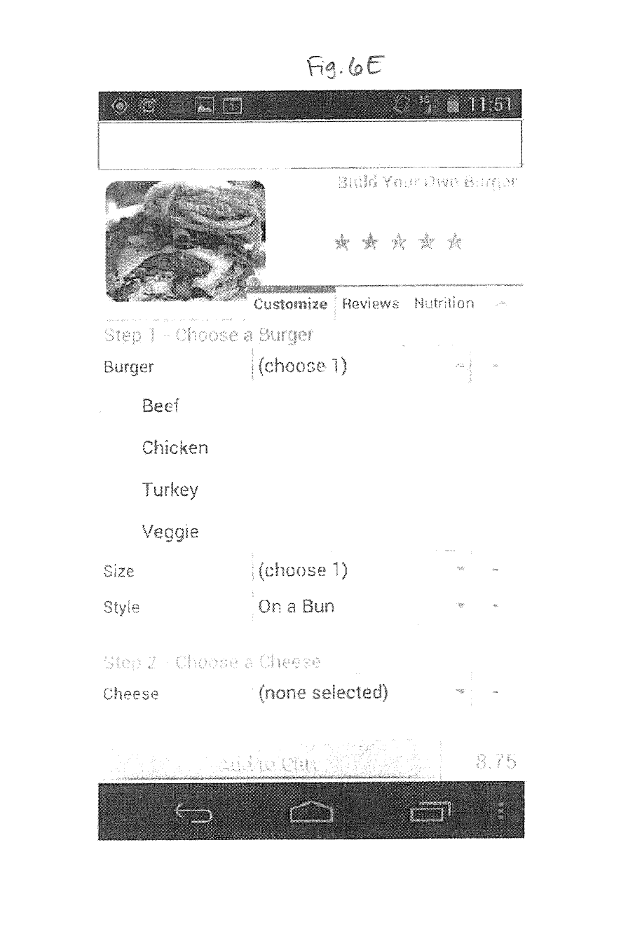

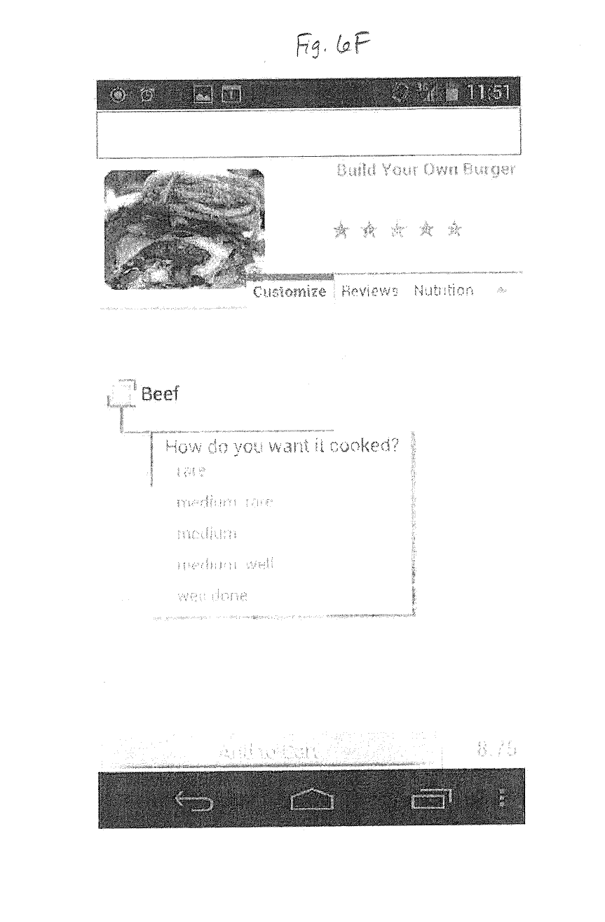

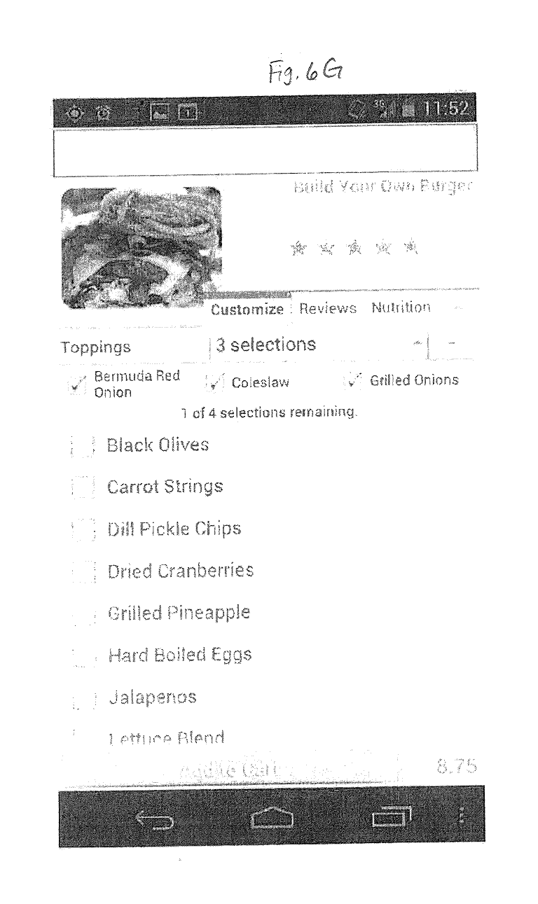

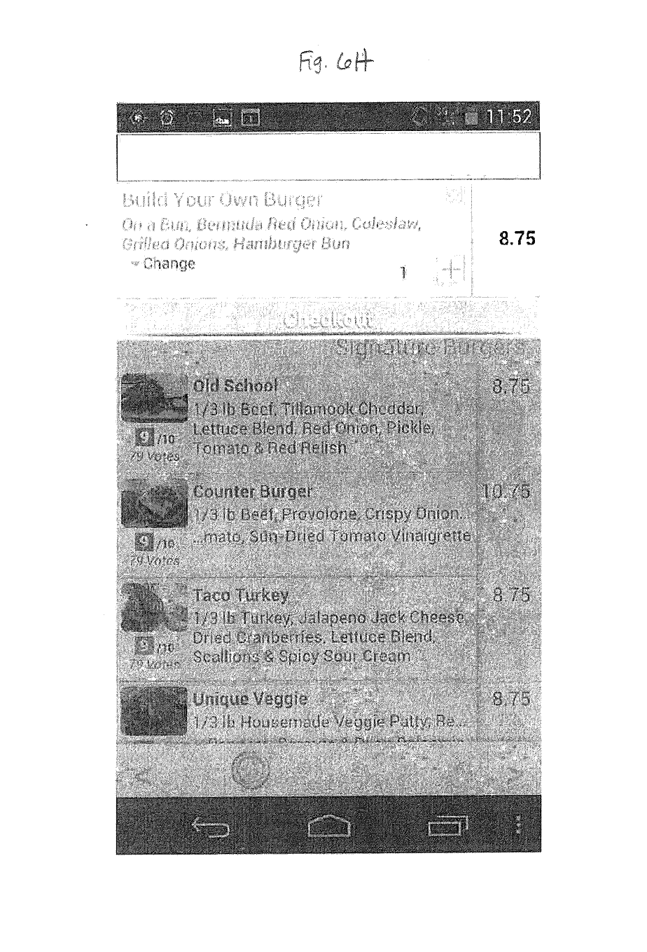

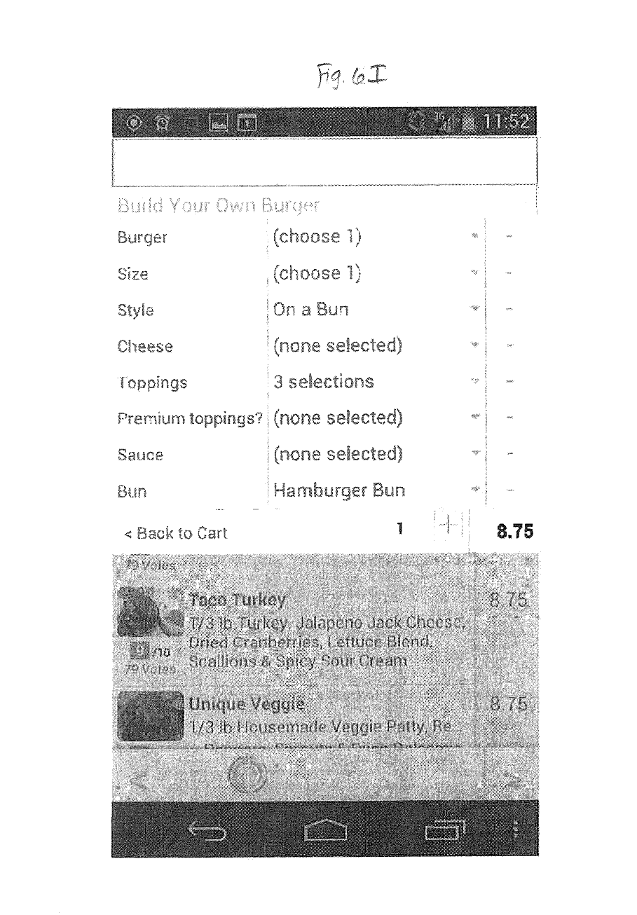

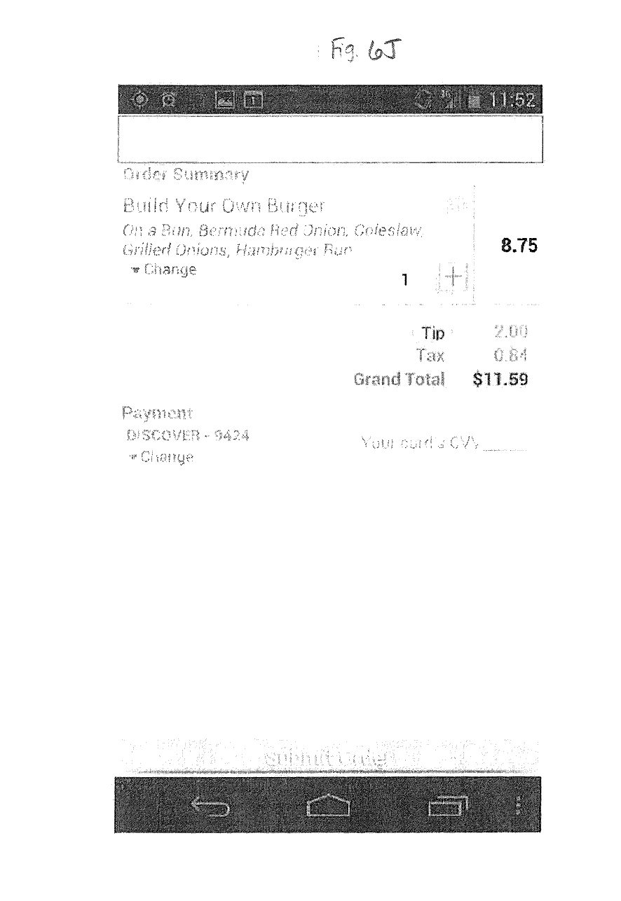

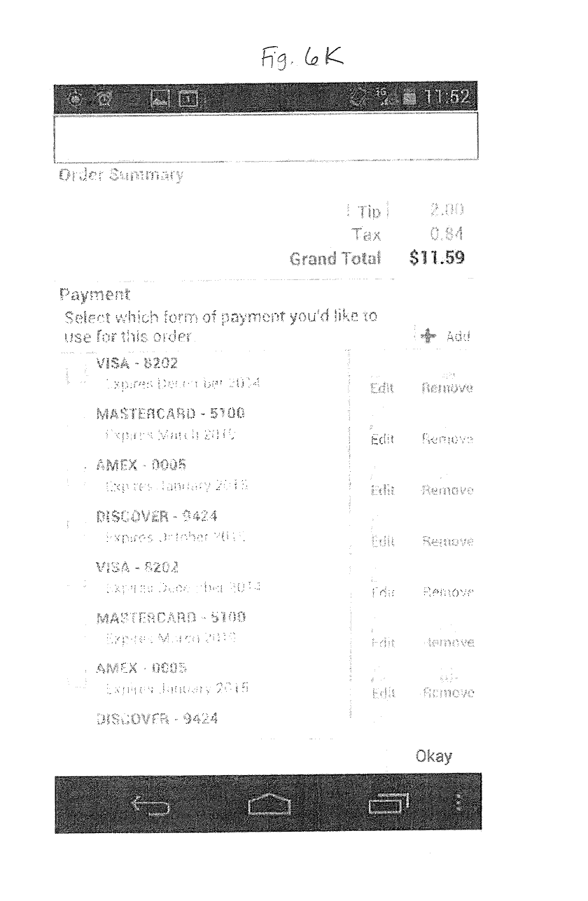

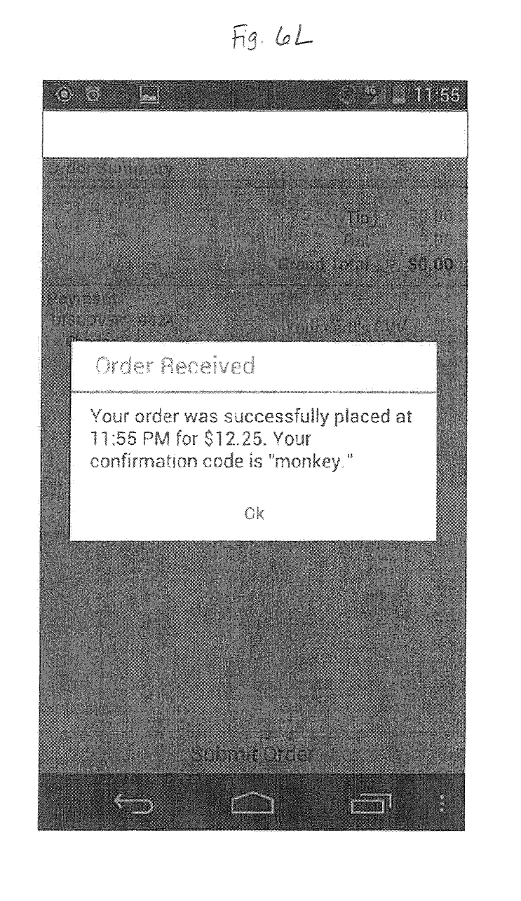

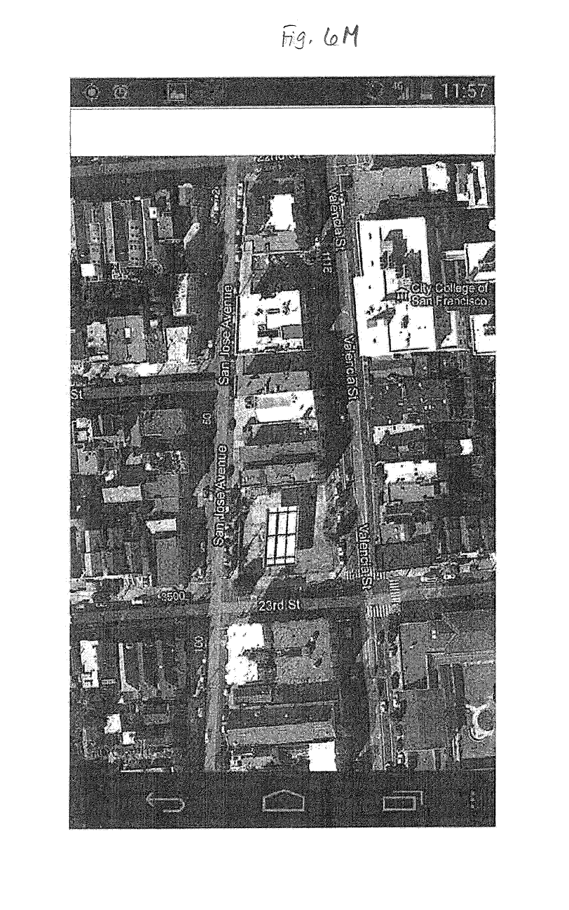

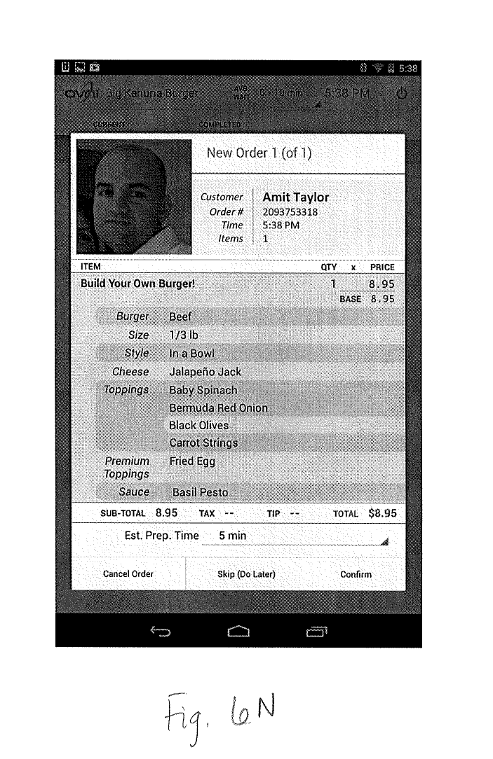

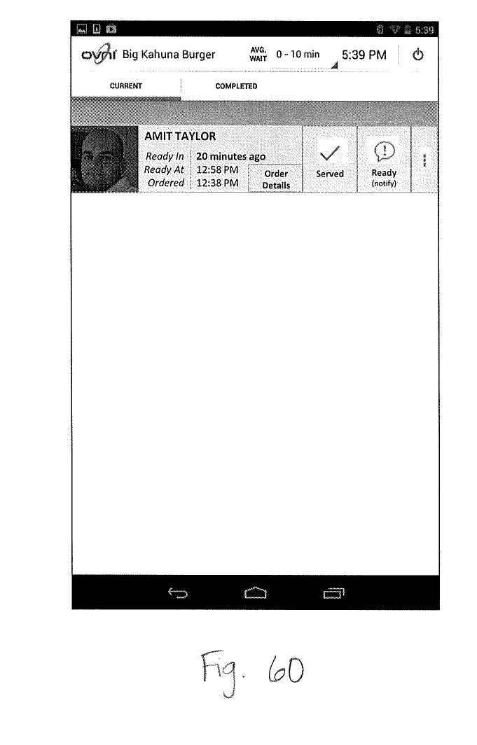

FIG. 1 illustrates an example system for remote ordering of goods and/or services. According to various aspects, the owner, or user of a wireless device 110, such as a smart phone, tablet or other device, may communicate via a network 120 with a server 130, the server 130 having a database or other data repository, including information relative to a plurality of vendors, retailers or service providers, such as restaurants, doctor's offices, flower shops, mechanics, and the like. According to various aspects, the wireless device 110 may display information relative to the plurality of vendors on a screen, as illustrated, for example, in FIG. 6A, and may perform various functions relative to the plurality of vendors displayed on the screen of the wireless device 110 via the server 130. For example, the user of the wireless device 110 may obtain location information regarding the plurality of vendors, may view the goods and services offered by the vendors 140, and/or may order goods and/or services from the vendors 140.

With respect to the server 130, according to various aspects, the server may be connected to a plurality of vendors 140 via a network 120, such as a local network, a wide area network, the Internet or the worldwide web or other network, and may collect information relative to the vendors 140, such as location, logo, and goods and services offered by the vendors 140. According to various aspects, an owner or manager of the server 130 may enter into an agreement with vendors 140 to receive information from the vendors 140 regarding the goods and services provided by the vendors 140, including, for example, a list of items provided by the vendors, as well as prices and availability of the items. According to various aspects, the user of the wireless device 110 may access this information via the connection between the wireless device 110 and the server 130. Accordingly, the server 130 may serve as a hub of information gathered about the goods and services provided by the vendors 140, as well as other information relative to the vendors 140. As a result, the user of the wireless device 110 may be able to view the goods and services offered by the vendors 140 and select and/or order goods and/or services desired.

According to various aspects, the user of the wireless device 110 may also effect payment of the selected goods and/or services via the server 130. For example, when the user of the wireless device 110 orders goods and/or services from a vendor 140, the user of the wireless device 110 may select the desired goods and/or services on the screen of the wireless device 110, and the order may be transmitted to the server 130. When the server 130 receives the information via the network 120, the server 130 may also require payment for the selected goods and/or services from the user of the wireless device 110. Upon payment by the user of the wireless device 110 by, for example, entering a credit card number, bank card number, or other form of payment information, via the wireless device, the payment information may be received at the server 130 and processed for payment. Accordingly, the user of the wireless device 110 may order goods and/or services from a vendor 140 without dealing directly with the vendor 140, at least in terms of payment and/or payment confirmation.

According to various aspects, upon receipt of the payment, the server 130 may transmit the order to the appropriate vendor 140, and/or provide the user of the wireless device with a confirmation of payment and of the fact that the order has been placed, along with a timeline for completion. For example, in the case of the vendor 140 being a restaurant and the order being an order for take-out, the server 130 may also receive from the restaurant/vendor 140 information as to the amount of time necessary for the take-out order to be ready, and the server 130 may transmit this information to the user of the wireless device 110. Alternatively, the vendor 140 may communicate directly with the wireless device 110 and provide a timeline, and/or one or more updates, for example, as to the amount of time necessary for the order to be completed. It should be noted that payment may be received at the server 130 either upon receipt of the order by the server 130, or later, such as upon receipt of the order at the selected vendor 140.

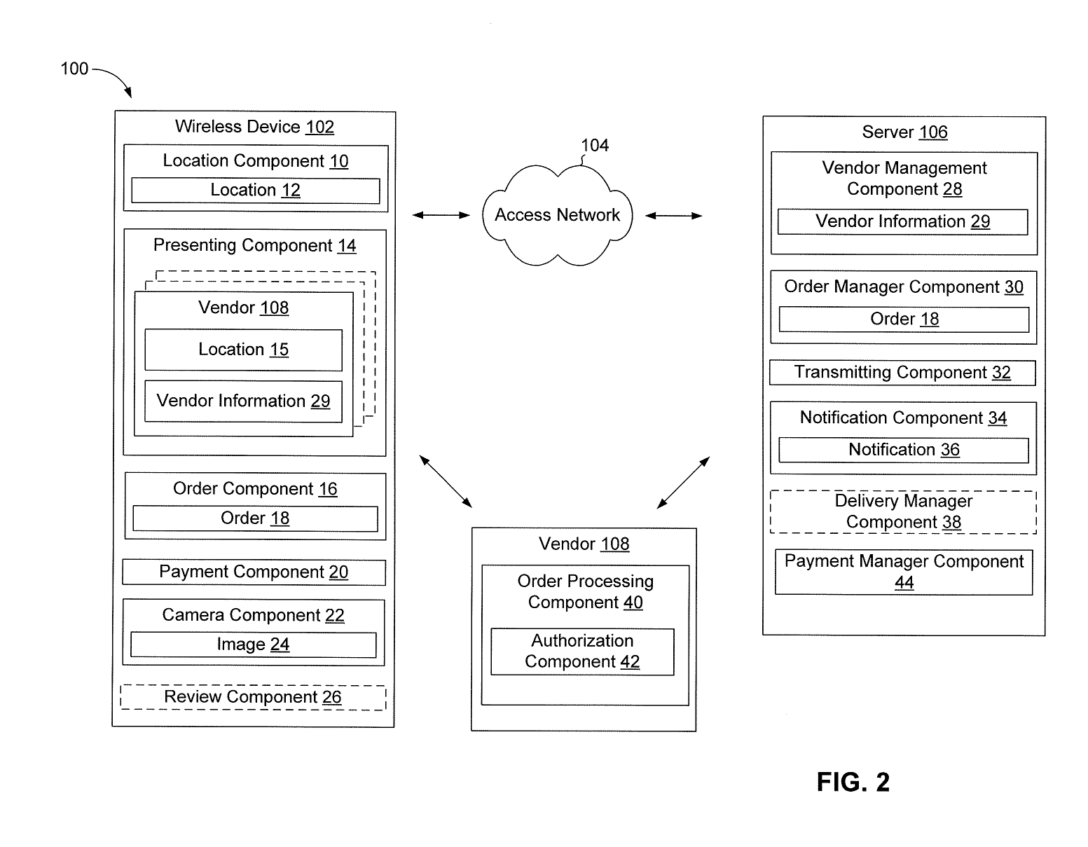

Referring now to FIG. 2, illustrated therein is an example connectivity system 100 in accordance with an aspect of the present invention. System 100 may include one or more wireless devices 102 communicating with one or more servers 106. In addition, system 100 may also include one or more vendors 108 in communication with wireless device 102 and/or server 106.

Wireless device 102 may be, for example, a cellular telephone, a smartphone, a wearable device, a navigation system, a computing device, a camera, a personal digital assistant (PDA), a music device, a gaming device, a digital versatile disk (DVD) player, or a handheld device having wireless connection capability, among other devices. In addition, wireless device 102 may be a television (TV) device including, but not limited to, Apple TV devices and Google TV devices, among other smart TV devices.

Wireless device 102 may include a location component 10 operable to provide a current location 12 of wireless device 102. For example, location component 10 may include a global positioning system (GPS) component and/or other location features. In an aspect, location component 10 may determine the current location 12 of wireless device 102 by using, for example, peer-to-peer communication links, such as Bluetooth, wifi-Direct, or near field communications. For example, location component 10 may use the wifi network of a vendor 108 to determine that the current location 12 of wireless device 102 is located near or inside vendor 108. Location component 10 may transmit the current location 12 of wireless device 102 to server 106.

Server 106 may receive location 12 from wireless device 102 and may determine one or more vendors 108 that may be near location 12. In an aspect, server 106 may have a vendor management component 28 operable to determine vendors 108 that may be near location 12. For example, vendor management component 28 may determine a radius from location 12 and retrieve vendor information 29 for each of the vendors 108 that are within the determined radius. Vendor information 29 may include, but is not limited to, a location of the vendor, a menu of items or services provided by the vendor, prices for the items and/or services, ratings of the items and/or services, and business hours of the vendor. For example, the radius may be 5 miles and vendor management component 28 may retrieve the vendor information 29 for each vendor 108 within 5 miles from wireless device 102. In an aspect, vendor management component 28 may filter the received vendor information 29 for vendors 108 that meet selected or predetermined criteria, such as, a minimum level of popularity. The minimum level of popularity may be based on reviews of users or a volume of orders placed by users, for example.

Vendor management component 28 may interface with transmitting component 32 and transmit the vendor information 29 to wireless device 102. Wireless device 102 may include a presenting component 14, such as one or more features operable to present the received vendor information 29 on a display or to provide the information audibly.

In an aspect, presenting component 14 may present for each vendor 108, a location 15 of the vendor and vendor information 29, such as a menu of items and/or services provided by vendor 108, and ratings of the items and/or services provided by vendor 108. As such, presenting component 14 may receive an aggregation of vendor information 29 from a plurality of vendors 108 and present the vendor information 29 in a uniform presentation on a user interface screen of wireless device 102, for example. A user may be able to view a plurality of vendor information 29 easily and select one or more items from a menu that the user may want to order from vendor 108. In an aspect, a user may filter the received vendor information 29 based on one or more criteria, including, but not limited to, a type of business, a location, pricing, whether delivery is available, ratings, and nutritional information.

Wireless device 102 may also have an order component 16 operable to receive a selection of menu items from presenting component that a user may want to order and may create an order 18 based on the selection of menu items. In an aspect, the menu items included in order 18 may be modified by a user. For example, the user may add and/or remove items from order 18 or otherwise customize the order. Order component 16 may transmit order 18 to server 106 for processing. Wireless device 102 may also include a camera component 22 operable to capture an image 24, such as an image of the user of wireless device 102. In an aspect, order component 16 may transmit order 18, along with image 24, to server 106. The image 24 may also be captured and sent to the server to be stored with the user's profile without an order taking place.

Order management component 30 may receive order 18 from wireless device 102, and transmitting component 32 may transmit order 18 to one or more vendors 108. Order management component 30 may optionally receive an image 24 from wireless device 102, and transmitting component 32 may transmit image 24 along with order 18 to vendor 108.

In an aspect, order management component 30 may integrate with a third party service, such as websites, other mobile applications, voice-activated systems, and devices (e.g., smart watches) that enable the third party service to place order 18 on behalf of the user. In addition, third party integration may also occur with the vendor management component 28 or other components of the system. Order management component 30 may integrate with the third party service via, for example, an application programming interface so that order 18 may be received by order management component 30 directly from the third party. For example, menu items for vendor 108 may be displayed on a third party website, such as Yelp, operated by Yelp, Inc. of San Francisco, Calif., and the user may be able to place an order for selected menu items directly from or otherwise using such third party website. Order management component 30 may receive order 18 directly from the third party, and transmitting component 32 may transmit order 18 to vendor 108.

Vendor 108 may have an order processing component 40 operable to receive and manage the completion of orders 18 received from server 106. Order processing component 40 may send a notification to order manager component 30 with an order status, for example. The order status may include, but is not limited to, confirming the order, estimating the time of delivery for the order, estimating a time for picking up the order, identifying when the order is ready for pick-up or delivery, marking the order as complete, and/or canceling the order.

Order manager component 30 may receive the notification from vendor 108 and may interface with notification component 34 on server 106 to send a notification 36 to wireless device 102 with an update on order 18. Notifications may include, but are not limited to, an e-mail message, a telephone call, a short message service (SMS) message, a multimedia messaging service (MMS) message, and/or an instant messaging (IM) service message. In addition, notifications may be received from vendor 108 and transmitted to wireless device 102 in real time/near real time as changes occur to the order 18. As such, a user may be able to track the status of order 18 through the received notifications.

Order processing component 40 may also integrate with different systems at vendor 108 to manage the completion of order 18. For example, order processing component 40 may integrate with systems in the kitchen of vendor 108 to place the order in the queue of the kitchen. Order processing component 40 may directly interface with the kitchen system and place the order in the kitchen queue. In another aspect, order processing component 40 may print a ticket with the order, and/or an individual at vendor 108 may place the ticket in the kitchen for processing.

In addition, order processing component 40 may send a payment request to payment manager component 44 on server 106 upon completion of the order. For example, when a user picks up an order from vendor 108, order processing component 40 may send a payment request to payment manager component 44 to receive payment for the order. Payment manager component 44 may also receive a payment request from payment component 20 on wireless device 102. For example, when a user picks up an order from vendor 108, payment component 20 may send a payment request to payment manager component 44 to pay for the order. As another example, if the vendor 108 requires payment before completing the order, then payment component 20 may send a payment request to payment manager component 44 at the same time that order component 16 sends the order 18 to server 106. In an aspect, payment manager component 44 may be operable to interface with a point of sale system for vendor 108 to process payment for the order. In addition, payment manager component 44 may interface with a third party payment processor to process payment for the order, or may process payments directly.

In an aspect, payment manager component 44 may save payment method data for the user. Thus, when the user subsequently places an order, payment manager component 44 may fetch the user's payment information from an internal database or from a secure 3rd party PCI-compliant service and may transmit the payment information to payment component 20 on wireless device 102 so that the user may select a payment method to pay for the order. When a user adds a new payment method, or updates/deletes existing payment methods, the changes may be forwarded to payment manager component 44. In another aspect, payment component 20 may store payment information for the user. In addition, payment manager component 44 may interface, for example, with a corporate payment account that employees can charge orders to and that allows companies to monitor and keep track of orders placed by employees.

In an aspect, order processing component 40 may have an authorization component 42 operable to aid in the verification of a user associated with order 18. Authorization component 42 may provide an image 24 forwarded with order 18 on a display at vendor 108, for example. In one example implementation, the individual at vendor 108 may compare the displayed image 24 with the user that arrives to pick up the items from order 18 and verify that the user is authorized to pick up the items. Individuals at vendor 108 may use authorization component 42 to easily recognize and confirm the identity of each user as each user arrives at vendor 108.

In another aspect, authorization component 42 may present images of individuals who are currently present at vendor 108 and may allow users to automatically pay for orders using the users' wireless devices 102, for example, without the users removing the wireless devices 102 from a pocket, a bag, or purse. For example, authorization component 42 may determine when a user is located inside or near vendor 108. Authorization component 42 may receive the current location 12 of wireless device 102 from server 106. In addition, authorization component 42 may receive the images 24 of any users that are inside or near vendor 108 from server 106 and may present the images of the users on a display. An individual at vendor 108 may select an image of the user placing an order at vendor 108 and may enter a payment amount for the order. Authorization component 42 may transmit the payment amount for the order to payment management component 44 and may automatically charge the user for the order. In an aspect, payment manager component 44 may interface with a point of sale system associated with server 106 to receive payment for the order. Thus, the payment for the order may be streamlined by recognizing that the user is within the vendor's location based, for example, on the location of the user's device and presenting an option for the vendor to charge the user, as identified by an image of the user presented to the vendor, without the user needing to interact with their wireless device to facilitate the payment (e.g., without the user needing to press “pay” on their device, or without the vendor needing to “scan” their device).

Server 106 may optionally include a delivery manager component 38 operable to manage the delivery of items included in order 18. Delivery of the items may be performed by a network of couriers, such as, but not limited to, couriers that are employed directly by vendors 108 or a crowd-sourced network of couriers. Delivery of the items may also be performed, for example, by unmanned vehicles, such as unmanned ground vehicles (UGVs) or unmanned aerial vehicles (UAVs). The unmanned vehicles may be autonomous or controlled by users of the system. In an aspect, the courier or unmanned vehicles may be instructed or controlled by a complex set of algorithms that optimize the delivery times of the items and the status of the couriers or unmanned vehicles. For example, delivery manager component 38 may provide the couriers with the pick-up location for the delivery (e.g., the location of vendor 108), the final destination (e.g., location 12 of wireless device 102), travel directions, and information about the order.

Delivery manager component 38 may also provide real time or near real time updates on the status of items scheduled for delivery. For example, delivery manager component 38 may receive near real time updates from the couriers of the status and location of items scheduled for delivery. In an aspect, delivery manager component 38 may interface with notification component 34 to transmit a notification 36 to wireless device 102 with the status of the delivery of items. The status may include, for example, an estimated delivery time, the current location of the order, and/or communication information (e.g., telephone number) of the courier that is delivering the order.

Delivery manager component 38 may also calculate an appropriate delivery fee for delivering the items. The delivery fee may be based upon the location of the user, the location of vendor 108, the distance between the user and vendor 108, the time of day, current traffic conditions, and current weather conditions. In an aspect, the delivery fee may be charged to either the user that ordered the items, the vendor 108 that provided the items, or split among the parties.

Upon receiving items from order 18, a user of wireless device 102 may use review component 26 to provide one or more reviews for the items ordered and/or the vendor 108 that provided the items. Vendor management component 28 may receive the reviews and may include the reviews with the vendor information 29 associated with the vendor 108.

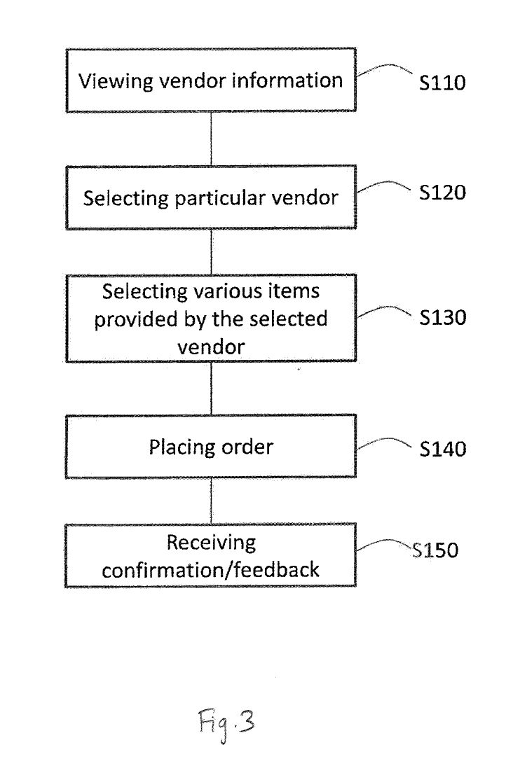

FIG. 3 is a flowchart illustrating a method for remote services ordering according to various aspects of the current invention. The method starts at S110, where vendor information is viewed on a user's wireless device screen. For example, the user's wireless device may display a screen similar to the screen illustrated in FIG. 6A. According to various aspects, the vendor logos illustrated in FIG. 6A may be provided by the vendor, and/or may also be generated via an application at the wireless device. Alternatively, symbols, characters or letters other than the official vendors' logos may also be generated via the application and displayed on the user's wireless device to refer to the various vendors. According to various aspects, the user may then select a particular vendor at S120. Furthermore, the vendors illustrated in FIG. 6A may also include rating information provided by other users. At S130, the user is then presented with a menu from the selected vendor which allows the user to choose from various items that the vendor provides. In the example illustrated in FIG. 6B, the user has selected a restaurant specializing in burgers, which is the second option from the top in the list of vendors illustrated in FIG. 6A. Accordingly, a menu of various burgers may be provided to the user of the wireless device, as illustrated in FIG. 6B.

According to various aspects, when the user has selected an item from a menu of items provided by the vendor, such as the menu of burgers illustrated in FIG. 6B, the user may also elect to customize the selection by selecting the customize icon as illustrated in FIG. 6C. Accordingly, the user may select other options to customize the user's order, as illustrated in FIG. 6D. In the example illustrated in FIG. 6D, the user may select the type of burger, the size and style of the burger, the type of cheese to be added to the burger, the toppings, the sauce, and/or other similar options. It should be noted that, although the above options are illustrated with reference to a restaurant, the same method can be applied to other vendors, retailers or service providers. FIG. 6E illustrates the selection by the user of the type of burger. For example, the user may select a beef, chicken, turkey or veggie burger at FIG. 6E. According to the illustrated example, the user has selected a beef burger, as shown in FIG. 6F, and further selects the way in which the beef burger should be cooked. It should be noted that the option of selecting the way in which the burger should be cooked may only be available if the user is in the process of ordering a beef burger. If the user selects a chicken burger, a turkey burger or a veggie burger, then this option may not be available, for example. The user may further select additional options, such as, toppings, as illustrated in FIG. 6G. According to various aspects, one or more pre-selected orders may also be stored at the wireless device to automatically populate the various menus of the vendor. In addition, the nutritional values of the various items available for selection may also be displayed, for example, upon selection by the user.

According to various aspects, when the user has selected all the desired options, the user may start the ordering process at S140, as illustrated in FIG. 6H. Even after an item has been customized and added to the cart, the user may have the ability to change specific elements of the order without having to start the order customization process from the beginning, as illustrated in FIG. 6I. When the user has selected all the desired options, then the running total may be displayed, together with a calculation of the tax and optionally the tip and or any delivery charges, if applicable to the user, as illustrated n FIG. 6J. FIG. 6K is an illustration of a step in the ordering process at which the user may select a specific credit card, bank card or other form of payment to use for paying the order. According to various aspects, the wireless device may have a pre-stored number of credit cards, bank cards, or other forms of payment for the user to choose from when placing the order, as illustrated in FIG. 6K. For example, the pre-stored credit cards, bank cards, or other forms of payment may be stored in an application of the wireless device or they may be stored with a third party service, and transmitted to the device from the server or directly from the third party service. When the user selects a given credit card or bank card, the transaction may be processed and the order may be placed during S140. According to various aspects, when the order has been completed, the user may receive confirmation of the completed order at S150, as illustrated in FIG. 6L. In addition, the user may receive a description of the pick-up location of the ordered item, if applicable, as illustrated in FIG. 6M.

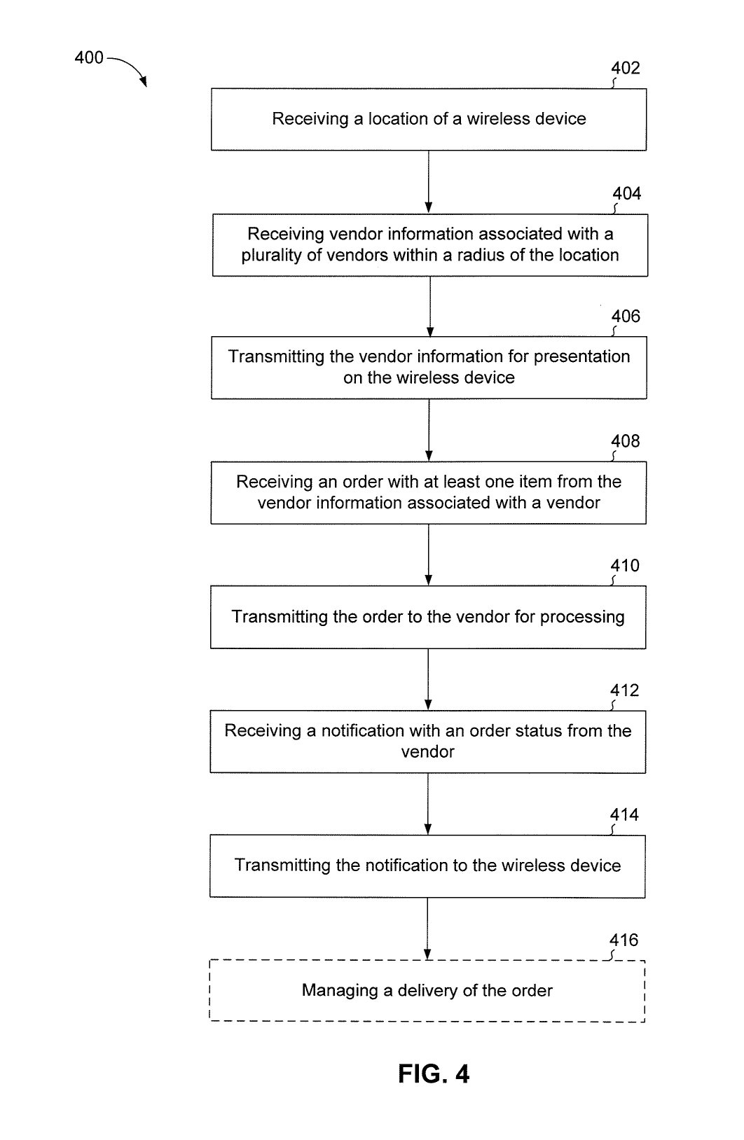

Referring now to FIG. 4, illustrated therein is an example method flow 400 for managing orders in accordance with an aspect of the present invention. The method may include receiving a location of a wireless device 402. In an aspect, a server 106 (FIG. 2) may receive a current location of a wireless device 102 (FIG. 2). The current location may include, but is not limited to, a home address, an address of an employer, a restaurant, a park, a city, a shopping center, an airport, and a location while driving in an automobile. For example, the location component on the wireless device may determine the current location through GPS systems or using peer-to-peer communication links, such as Bluetooth, wifi-Direct, or near field communications.

The method may also include receiving vendor information associated with a plurality of vendors within a radius of the location 404. For example, server 106 may determine a radius from the received location and retrieve vendor information for each of the vendors that are within the determined radius. Vendor information may include, but is not limited to, a location of the vendor, a menu of items or services provided by the vendor, prices for the items and/or services, ratings of the items and/or services, and business hours of the vendor. In an aspect, the server may filter the received vendor information for vendors that meet criteria, such as, a minimum level of popularity or a quality level. In addition, the vendor information may be retrieved based on other criteria. For example, a user may have a list of favorite vendors whose information the user would like to retrieve regardless of location or proximity of the user to the vendor.

The method may also include transmitting the vendor information for presentation on the wireless device 406. For example, server 106 may transmit the received vendor information to wireless device 102 for presentation.

The method may include receiving an order with at least one item from the vendor information associated with a vendor 408. For example, server 106 may receive the order from a wireless device with at least one item selected from the vendor information. In an aspect, server 106 may receive an image from wireless device 102 and may associate the received image with the received order.

In addition, the method may include transmitting the order to the vendor for processing 410. For example, server 106 may transmit the received order to the vendor for processing. In addition, server 106 may transmit the received image from wireless device, along with the order to the vendor.

The method may include receiving a notification with an order status from the vendor 412. The order status may include, but is not limited to, confirming the order, estimating the time of delivery for the order, estimating a time for picking up the order, identifying when the order is ready for pick-up or delivery, marking the order as complete, and/or canceling the order. For example, server 106 may receive a notification from the vendor in near real time with the order status.

The method may also include transmitting the notification to the wireless device 414. Notifications may include, but are not limited to, an e-mail message, a telephone call, an SMS message, a MMS message, and/or an IM message. For example, server 106 may send a notification to wireless device 102 in near real-time with the order status.

Optionally, the method may include managing a delivery of the order 416. In an aspect, server 106 may manage the delivery of the received order from the vendor to the user of the wireless device that placed the order. Delivery of the items may be performed by a network of couriers, such as, but not limited to, couriers that are employed directly by vendors and a crowd-sourced network of couriers. Delivery of the items may also be performed, for example, by unmanned vehicles, such as UGVs or UAVs.

In an aspect, the courier or unmanned vehicles may be instructed or controlled by the server with a complex set of algorithms that optimize the delivery times of the items and the status of the couriers or unmanned vehicles. For example, the server may provide the couriers with the pick-up location for the delivery (e.g., the location of the vendor), the final destination (e.g., the location of the wireless device), travel directions, and/or information about the order. In addition, the server may provide real time or near real time updates on the status of items scheduled for delivery. For example, the server may receive near real time updates from the couriers of the status and location of items scheduled for delivery.

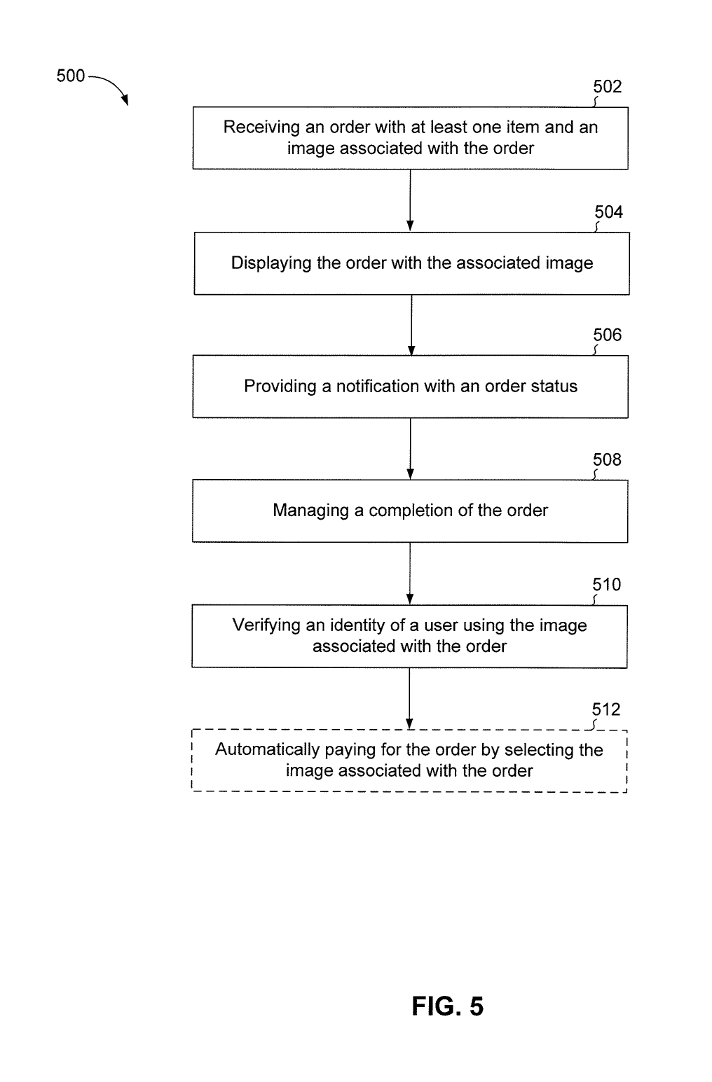

Referring now to FIG. 5, illustrated therein is an example method flow 500 for processing an order in accordance with an aspect of the present invention. The method may include receiving an order with at least one item and an image associated with the order 502. For example, a computing system at a vendor 108 (FIG. 2) may receive an order and an image associated with the order from server 106 (FIG. 2).

The method may include displaying the order with the associated image 504. In an aspect, the computing system may present the order and the image on a display of the computing system, as illustrated, in FIGS. 6N and 6O. The image may include, for example, an image of the user who placed the order.

The method may also include providing a notification with an order status 506. The order status may include, but is not limited to, confirming the order, estimating the time of delivery for the order, estimating a time for picking up the order, identifying when the order is ready for pick-up or delivery, marking the order as complete, and/or canceling the order. For example, the computing system may send notifications to server 106 with the order status as changes occur to the order. As such, the status of order may be tracked through the received notifications.

The method may include managing a completion of the order 508. For example, the computing system may integrate with different systems at the vendor to manage the completion of the order. In an aspect, the computing system may integrate with systems in the kitchen of vendor to place the order in the queue of the kitchen.

In addition, the method may include verifying an identity of a user using the image associated with the order 510. In an aspect, the computing system may use the displayed image forwarded with the order to aid in the verification of a user picking up an order. In one example, an individual at the vendor may compare the displayed image with the user who arrives to pick up the items from order and verify that the user is authorized to pick up the items. Thus, individuals at the vendor may use the displayed images to easily recognize and confirm the identity of users when arriving at the vendor.

The method may optionally include automatically paying for the order by selecting the image associated with the order 512. In another aspect, the computing system may present images of individuals who are currently present at the vendor and may interface with a point of sale system to allow users to automatically pay for orders using the users' wireless devices, for example, without the users removing the wireless devices from pockets, bags, or purses. For example, authorization component 42 (FIG. 2) may determine when a user is located inside or near vendor 108 (FIG. 2) by receiving the current location of wireless device 102 (FIG. 2) from server 106 (FIG. 2). The computing system may present the images of the users located inside or near the vendor on a display. An individual at the vendor may select an image of the user placing an order at the vendor and may enter a payment amount for the order. The computing system may interface with a point of sale system and may automatically charge the user for the order and receive payment for the order.

With respect to the example application of restaurant food ordering, advantages in accordance with aspects of the current invention may also include 1) the concept of creating, aggregating, and presenting a set of virtualized, restaurant sub-applications that exist within a primary, actual application. These virtual, sub-applications may be presented with a uniform UI (user interface)/UX (user experience), or the UI/UX for a given sub-application may be tailored for a specific restaurant chain, business or establishment; 2) customizing a restaurant menu for a customer's specific preferences and health requirements; 3) creating a personalized score for specific food items at a restaurant using a combination of customer ratings and customer order history data; 4) including a picture/photograph of each restaurant menu item in an electronically-presented restaurant menu, and allowing users of the application to upload their own photos of the item; 5) for restaurant chains, the use of restaurant menus within the application that are applicable to a set of restaurants within the chain, as well as menus that are tailored or are only applicable to a particular restaurant within the chain; 6) presenting restaurant menu pages in a mobile application in a manner that mimics and enhances or builds upon the structure of a traditional physical restaurant menu having a digital restaurant menu that is structured in a series of “pages”—each page containing a tree-hierarchy of nested restaurant menu categories and restaurant menu order items of arbitrary depth and users may expand/show or collapse/hide branches within this tree-hierarchy as they wish, allowing users to sequentially “flip/swipe” through pages of a digital restaurant menu in a way that mimics flipping through the pages of a physical restaurant menu, the ability for a user to quickly navigate, non-sequentially, to a particular restaurant menu page by accessing an index list of pages in the restaurant menu and selecting from that list the menu page to which to navigate, for each menu page, the ability for a user to access a list of categories and subcategories on that page, from which the user may select a particular category/sub-category to which to navigate/scroll/jump, the ability for a user to specify certain aspects of a restaurant menu item for ordering, such as portion/size, such that the item may be added to the user's cart without leaving the current menu page view, and use of pluggable, customizable ratings bars and icons to present additional information on a restaurant menu item.

Other advantages in accordance with aspects of the current invention include:
presenting nutritional information for specific restaurant food items in a wireless device application, including presenting both nutritional information, such as the number of calories, and allergy information, for example, an indication that an item contains peanuts;
the ability for a user to customize any and every aspect of a restaurant order item within a single ‘page view’ of a mobile device application, creating an accordion-style list that expands and/or contracts to reveal/hide different nested customization options as selected by the user (the user is allowed to expand/collapse sections of the menu that they wish to show/hide, for example), which may allow for an unlimited number of different options to be customized on a single application screen view, the use of checkboxes/radio buttons in conjunction with modal pop-ups/dialogs for presenting conditional customization options to a user, wherein the set of sub-customizations presented in a modal pop-up/dialog for a checkbox/radio button depends on whether said checkbox/radio button is checked or unchecked, selection-dependency (the revealing/enabling or hiding/disabling of item customizations within the accordion-style list, based on the selection or non-selection of other customizations within the list), use of pluggable, customizable ratings bars and icons to present customization options in a manner other than just text, such as allowing a user to highlight or select a number of chili pepper icons in order to specify desired spiciness, or allowing a user to select a full circle, left-half circle, or right-half circle to indicate to which side of a pizza he/she would like to add topping(s)—these plug-ins may be created and specified on a per-customization-option basis;
after an item has been added to the electronic shopping cart, allowing that item to be customized from the shopping cart without having to go back to the item's customization page, including the ability to adjust the quantity of the item within the cart;
when allowing an item to be customized/altered from the shopping cart, the use of a “folding” list whereby the cart item that is being customized/altered remains visible within the list, but all other cart items below and above the item are hidden from view or slid/folded underneath the item until the user has finished customizing/altering the cart;
the ability to present a “quick-view” or “preview” of items within the electronic shopping cart, which enables the same or similar functionality to the cart itself, but avoids leaving the current page of the application or directing the user to a dedicated page for the cart;
using a tablet computer/device at a business to receive orders via wireless/mobile networks that a customer placed via the wireless device;
using a tablet computer/device at a business to cancel received orders that were placed by a customer via the user's wireless device, technology that allows physical tickets/receipts for received orders to be printed from the tablet, technology that allows digital tickets/receipts for received orders to be broadcast/forwarded to other, satellite electronic devices, such as digitally sending an order that was received on the tablet at the front counter of a restaurant to another device/monitor in the kitchen;
using a tablet computer/device at a business to communicate with, send messages and updates to, and receive responses from a customer about an order that was placed via the customer's wireless device, including, but not limited to, the availability of ingredients and estimated preparation time; communication may be facilitated through text/email/voice messages, or may be facilitated, for example, through real-time voice communications via the telephone/calling capabilities of the customer's wireless device and/or the tablet computer/device at the business;
integrating a mobile application on a customer's telephone device with the point-of-sale device at a restaurant to facilitate a seamless order and payment experience for all parties, integrating that application with a variety of different point-of-sale brands through an application programming interface (API);
the ability to enable a user to specify a time at which to pick up an order and then using algorithms to manage that order, so that it is indeed prepared at the desired time;
the ability to page a waiter at a restaurant to the user's table from the user's own wireless device;
the ability to save a person's favorite orders and past orders for performing a “1-click” order;
using a customer's order history to automatically track a loyalty program and give loyalty rewards;
allowing businesses to offer deals to specific users based on their ordering history;
providing businesses a control panel that enables them to customize how their business appears in a platform application service;
providing businesses the ability to specify their location online in 2 or 3 dimensional space and then associate certain digital elements with their business and that space;
allowing/disallowing users to view certain restaurant menus and/or certain portions of restaurant menus, or to order certain items within a restaurant menu, based on time of day, hours of operation of the restaurant, user preference, or item availability at the restaurant;
Check/Bill-splitting—the ability for a party of users to contemporaneously use the application to order food, either on a single device or on multiple devices, and place a group order or a set of orders on behalf of the party—the bill for the order/set of orders may be easily and arbitrarily apportioned and paid for, via the application, among multiple payment methods provided by users within the party, regardless of which item(s) in the order were placed by which users within the party and which item(s) in the order were placed on which devices.

Other advantages of aspects of the current invention include:
the concept of representing locations in 2-dimensional or 3-dimensional space in a mobile device application (instead of just treating the locations as single points in space), which allows for more accurate positioning of a device relative to a location, allows the ability to determine if a device is inside a defined region (regions may be n-sided polygons, circles, lines, points, or any other 2-dimensional or 3-dimensional space, limited only such that it is theoretically possible to define its bounds through mathematical equations/formulas/functions, regions may be stationary or moving);
only allowing individuals/parties inside a defined physical region to access certain features of a mobile software application;
use of geolocation technology to create a virtual/digital realm that is accessible by devices in a defined physical location/region; the “realms” may be “smart” sites, in that the realms may allow a user within the realm to have an actual impact/effect on the physical space by initiating some action in its virtual counterpart—for example, the ability to walk into a Starbucks, pull out a wireless device, and select the next song that will be played in the Starbucks, facilitating interactions among devices with access to said virtual/digital realm, as well as interactions among said devices and the virtual/digital realm itself, and among said devices and the physical region for which the virtual/digital realm is defined;
allowing people to interact with businesses on wireless devices; for example allowing people to order food from a restaurant on the wireless device while being in the restaurant;
enabling wireless device users to discover and learn about the businesses around them;
the ability to order from multiple restaurants on a single mobile application;
providing businesses with a computer dashboard that enables a business to view data and statistics on their customers; and
offering deals to wireless device users based upon their location, preferences and history.

One example variation of the present invention may include using the methods and systems of the present invention to create a virtual real-estate platform for selling, trading or regulating real-estate. For example, the virtual real-estate platform may organize digital content relating to real-estate into a distinct virtual domain corresponding to a real-world location/region. Actions on the virtual real-estate platform may have a direct or indirect, real time or eventual impact on the real world location to which it is bound, and vice versa. Such virtual real estate, in conjunction with the real world location to which it is bound, may provide features including, but not limited to, “augmented” reality, personalized shopping experiences, and the enabling/disabling of certain functionality within either the virtual real estate or its real world counterpart, based on any suitable combination of user's physical location and authentication with the virtual real estate. In addition, the virtual real estate could be sold, rented, or traded. The virtual real estate platform may store and manage the virtual real-estate, and the associated location, digital content, features, services, functionality, and ownership.

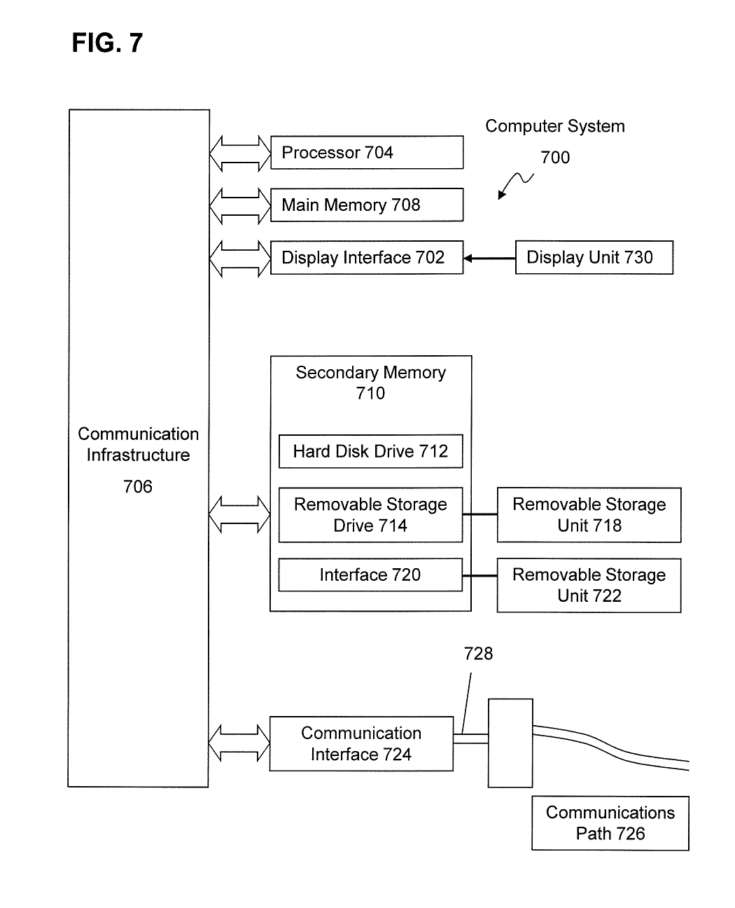

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 700 is shown in FIG. 7.

Computer system 700 includes one or more processors, such as processor 704. The processor 704 is connected to a communication infrastructure 706 (e.g., a communications bus, cross-over bar, or network). Various software aspects are described in terms of this exemplary computer system. After reading this description, it will become apparent to a person skilled in the relevant art(s) how to implement aspects of the invention using other computer systems and/or architectures.

Computer system 700 can include a display interface 702 that forwards graphics, text, and other data from the communication infrastructure 706 (or from a frame buffer not shown) for display on a display unit 730. Computer system 700 also includes a main memory 708, preferably random access memory (RAM), and may also include a secondary memory 710. The secondary memory 710 may include, for example, a hard disk drive 712 and/or a removable storage drive 714, representing a floppy disk drive, a magnetic tape drive, an optical disk drive, a universal serial bus (USB) flash drive, etc. The removable storage drive 714 reads from and/or writes to a removable storage unit 718 in a well-known manner. Removable storage unit 718 represents a floppy disk, magnetic tape, optical disk, USB flash drive etc., which is read by and written to removable storage drive 714. As will be appreciated, the removable storage unit 718 includes a computer usable storage medium having stored therein computer software and/or data.

Alternative aspects of the present invention may include secondary memory 710 and may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728, which may be electronic, electromagnetic, optical or other signals capable of being received by communications interface 724. These signals 728 are provided to communications interface 724 via a communications path (e.g., channel) 726. This path 726 carries signals 728 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 780, a hard disk installed in hard disk drive 770, and signals 728. These computer program products provide software to the computer system 700. Aspects of the invention are directed to such computer program products.

Computer programs (also referred to as computer control logic) are stored in main memory 708 and/or secondary memory 710. Computer programs may also be received via communications interface 724. Such computer programs, when executed, enable the computer system 700 to perform the features in accordance with aspects of the present invention, as discussed herein. In particular, the computer programs, when executed, enable the processor 704 to perform the features in accordance with aspects of the present invention. Accordingly, such computer programs represent controllers of the computer system 700.

In an aspect of the present invention that is implemented using software, the software may be stored in a computer program product and loaded into computer system 700 using removable storage drive 714, hard drive 712, or communications interface 720. The control logic (software), when executed by the processor 704, causes the processor 704 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, features thereof is implemented using a combination of both hardware and software.

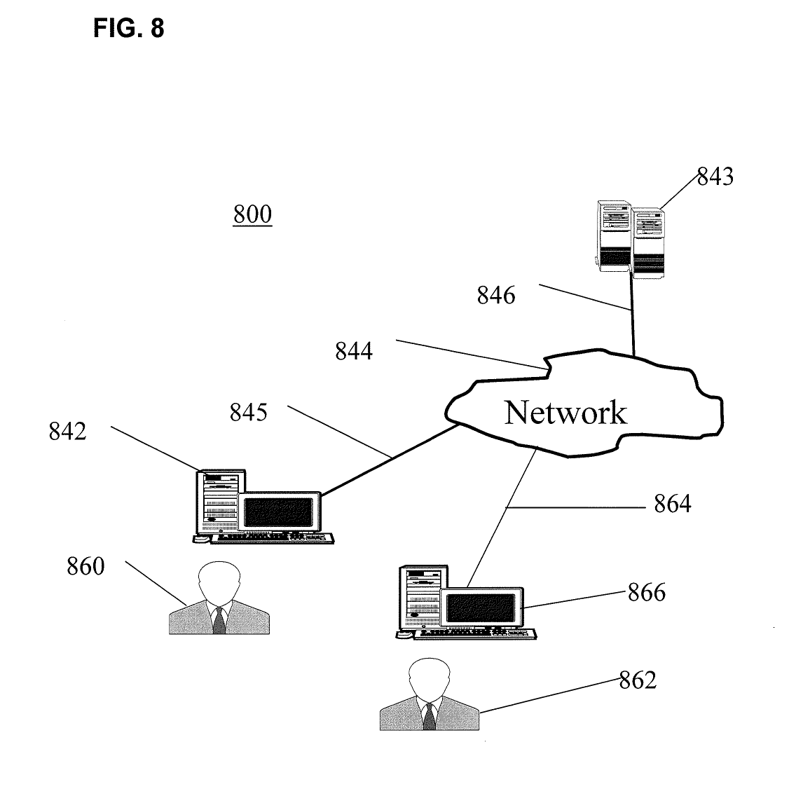

FIG. 8 shows a communication system 800 usable in accordance with aspects of the present invention. The communication system 800 includes one or more accessors 860, 862 (also referred to interchangeably herein as one or more “users”) and one or more terminals 842, 866. In one aspect of the present invention, data for use is, for example, input and/or accessed by accessors 860, 862 via terminals 842, 866, such as personal computers (PCs), minicomputers, mainframe computers, microcomputers, telephonic devices, or wireless devices, such as personal digital assistants (“PDAs”) or a hand-held wireless devices coupled to a server 843, such as a PC, minicomputer, mainframe computer, microcomputer, or other device having a processor and a repository for data and/or connection to a repository for data, via, for example, a network 844, such as the Internet or an intranet, and couplings 845, 846, 864. The couplings 845, 846, 864 include, for example, wired, wireless, or fiberoptic links. In another variation in accordance with aspects of the present invention, the method and system operate in a stand-alone environment, such as on a single terminal.

While aspects of the present invention have been described in connection with examples thereof, it will be understood by those skilled in the art that variations and modifications of the aspects of the present invention described above may be made without departing from the scope hereof. Other aspects will be apparent to those skilled in the art from a consideration of the specification or from a practice in accordance with aspects of the invention disclosed herein.

1. A method of managing orders of items, the method comprising:
receiving vendor information associated with a plurality of vendors;
transmitting the vendor information for presentation on a wireless device;
receiving an order from the wireless device, wherein the order includes a selection of at least one item from the vendor information associated with a vendor;
transmitting the order to the vendor for processing;
receiving a notification in real time or near real time with an order status from the vendor; and
transmitting the notification to the wireless device.

2. The method of claim 1, wherein the vendor information comprises one or more selected from a group consisting of a location of the vendor, a menu of items or services provided by the vendor, prices for the menu items, ratings, and business hours of the vendor.

3. The method of claim 1, further comprising:
receiving a location of the wireless device;
wherein the vendor information is received for vendors within a radius of the location of wireless device.

4. The method of claim 1, further comprising:
managing a delivery of the order from the vendor to the location of the wireless device, wherein managing the delivery further comprises managing a courier or an unmanned vehicle.

5. The method of claim 4, wherein managing the delivery of the order further comprises:
providing real time or near real time updates of a delivery status of the order.

6. A system for managing orders of items, the system comprising:
a vendor management component configured to be operable to receive vendor information associated with a plurality of vendors;
a transmitting component configured to be operable to transmit the vendor information for presentation on a wireless device;
an order manager component configured to be operable to receive an order from the wireless device, wherein the order includes a selection of at least one item from the vendor information associated with a vendor, and configured to transmit the order to the vendor for processing; and
a notification component configured to be operable to receive a notification in real time or near real time with an order status from the vendor and configured to transmit the notification to the wireless device.

7. The system of claim 6, wherein the vendor information comprises one or more selected from a group consisting of a location of the vendor, a menu of items or services provided by the vendor, prices for the menu items, ratings, and business hours of the vendor.

8. The system of claim 6, wherein the vendor management component is further configured to be operable to receive a location of the wireless device and retrieve vendor information for vendors within a radius of the location of wireless device.

9. The system of claim 6, further comprising:
a delivery manager component configured to be operable to manage a delivery of the order from the vendor to the wireless device, wherein managing the delivery further comprises managing a courier or an unmanned vehicle.

10. The system of claim 9, wherein the delivery manager component is further configured to be operable to provide near real-time updates of a delivery status of the order.

11. A computer product comprising a computer usable medium having control logic stored therein for causing the computer to perform order management, the control logic comprising:
at least one instruction for causing the computer to receive vendor information associated with a plurality of vendors;
at least one instruction for causing the computer to transmit the vendor information for presentation on a wireless device;
at least one instruction for causing the computer to receive an order from the wireless device, wherein the order includes a selection of at least one item from the vendor information associated with a vendor;
at least one instruction for causing the computer to transmit the order to the vendor for processing;
at least one instruction for causing the computer to receive a notification in real time or near real time with an order status from the vendor; and
at least one instruction for causing the computer to transmit the notification to the wireless device.

12. A method of processing an order, the method comprising:
receiving an order with at least one item and an image associated with the order;
displaying the order with the associated image;
providing a notification with an order status; and
managing a completion of the order.

13. The method of claim 12, wherein the order status comprises one or more selected from a group consisting of an order confirmation, an estimated time of delivery, an estimated pick up time, identifying when the order is ready for pick-up or delivery, a completed order, and an order cancelation.

14. The method of claim 12, wherein managing the completion of the order further comprises:
integrating with one or more systems at a vendor to complete the order.

15. The method of claim 12, further comprising:
verifying an identity of a user picking up the order using the image associated with the order.

16. The method of claim 12, further comprising:
receiving a location of a wireless device;
determining whether the location is within a radius of a vendor;
displaying the image of a user associated with the wireless device when the wireless device is within the radius of the vendor; and
automatically paying for the order by selecting the image when the wireless device is within the radius of the vendor.

17. A system of processing an order, the system comprising:
an order processing component configured to:
receive an order with at least one item and an image associated with the order;
display the order with the associated image;
provide a notification with an order status; and
manage a completion of the order.

18. The system of claim 17, wherein the order status comprises one or more selected from a group consisting of an order confirmation, an estimated time of delivery, an estimated pick up time, identifying when the order is ready for pick-up or delivery, a completed order, and an order cancelation.

19. The system of claim 17, wherein the order processing component is further configured to integrate with one or more systems at a vendor to complete the order.

20. The system of claim 17, further comprising:
an authorization component configured to verify an identity of a user picking up the order using the image associated with the order.

21. The system of claim 17, further comprising:
an authorization component configured to receive information from a server listing wireless devices that are within a radius of a vendor, and to display the images of the users associated with the wireless devices when the wireless devices are within the radius of the vendor; and
a payment manager component configured to automatically pay for the order by selecting the image when the wireless device is within the radius of the vendor.

22. A computer product comprising a computer usable medium having control logic stored therein for causing the computer to process an order, the control logic comprising:
at least one instruction for causing the computer to receive an order with at least one item and an image associated with the order;
at least one instruction for causing the computer to display the order with the associated image;
at least one instruction for causing the computer to provide a notification with an order status; and
at least one instruction for causing the computer to manage a completion of the order.

23. A method of ordering items, comprising:
providing a location of a wireless device;
receiving vendor information for presentation on the wireless device;
displaying vendor and item information on the wireless device;
selecting at least one item from the vendor information associated with a vendor for an order;
transmitting the order for processing; and
receiving a notification in near real-time with an order status from the vendor.

24. A system of ordering items, comprising:
a location component configured to provide a location of a wireless device;
a presentation component configured to receive vendor information for presentation on the wireless device and display vendor and item information on a wireless device using a design; and
an order component configured to select at least one item from the vendor information associated with a vendor for an order, transmit the order for processing, and receive a notification in near real-time with an order status from the vendor.
